(19) United States
(12) Patent Application Publication
(10) Pub. No.: US 2006/0152024 A1
(43) Pub. Date: Jul. 13, 2006

(54) Device for the collection and disposal of animal waste

(76) Inventor: Keith Edward Borngesser, Brookfield, WI (US)

Correspondence Address: Richard S Missimer, PO Box 511224, New Berlin, WI, 53151-1224, US

(21) Appl. No.: 11/334,859

(22) Filed: Jan. 19, 2006

Related U.S. Application Data
(63) Continuation-in-part of application No. 10/970,970, filed on Oct. 21, 2004, now abandoned.

(51) Int. Cl. A01K 29/00

(52) U.S. Cl. 294/1.3

(57) ABSTRACT

This invention is a new design for an animal waste collection and disposal device, as set forth in this specification. The claimed tool is, most often, used by pet owners to remove feces in accordance with local ordinances, and for the health and safety of all. This device allows the pet owner to remove excrement without having to handle the waste material, and in a way that contains the waste material throughout the disposal process. This device is manufactured in a way that all parts of the main tube body are molded in a one or two mold process, and which reduce the cost of the device and increases customer satisfaction. Customer satisfaction is driven by the device's ease of storage, weight, and ability to be kept clean. This device a truly the state of the art in the removal of pet and animal waste.

### CROSS-REFERENCE TO RELATED APPLICATION

This is a (CIP) continuation of non-provisional patent application Ser. No. 10/970,970 filed 2004 Oct. 23, now abandoned, by this inventor.

### FIELD OF THE INVENTION

This invention relates generally to devices that scoop up and dispose of animal or pet waste.

### BACKGROUND OF INVENTION

Pet (or animal) waste has become a growing concern for the larger cities across this great nation. As cities grow, both human and pet populations grow. Pet waste adds to the pollution of our waters and landscape. It is a complaint of those without pets that want to share the limited park and public areas, themselves or with their children, without concern for its presence. Pet waste is their concern because of its unsanitary nature, and its ability to be tracked into cars, homes, and on clothing. It has thus fallen on to the pet owners to clean-up after their pets. Some take this matter seriously; others do so at their convenience.

To motivate these owners to clean up after their pets, many cities have imposed ordinances to make pet owners responsible for their pet's waste. Cities such as Los Angeles, New York and Chicago have imposed fines for $20 (or more) on pet owners or walkers who do not pick up after their pets in public areas or property other than their own.

Today, there are solutions to ease the handling of such waste. However, the existing devices are costly, troublesome to operate, may require being under the pet at the time, and can be hard to keep clean.

### DISCUSSION OF THE PRIOR ART

Virtually all of the prior art is essentially an extension of a shovel or scoop like device at the end of a stick or pole. Their functionality is similar to that of the dust pans used in theaters and hotels long ago. For example, U.S. Pat. No. 4,149,745 (Willis, 04/1979) is a tubular scoop at the end of a pole (or handle) that is moved across the ground and debris is collected in a bag (also at ground level) at the alternative end of the tube. That device does establish the use of bags to dispose of pet waste and does use a retainer to do so. U.S. Pat. No. 6,260,895 (Nichols, 7/2001) which incorporates a bag and holder to a rack-like collection device; U.S. Pat. No. 6,190,600 (Lipniarski, 2/2001) and U.S. Pat. No. 6,237,973 (DuPont, 5/2001) which are based on a flat bottomed scoop and its predecessor U.S. Pat. No. 6,135,520 (Miller et al, 10/2000) is another scoop and cover type device; or U.S. Pat. No. 6,113,166 (Wynn, 9/2000) is a scoop and bag on the end of a pole. Basically, there are many such devices each with their own slight twist, but basically still a scoop or a shovel at the end of a pole.

A more innovative approach is U.S. Pat. No. 6,485,073 (Harrison, 11/2002) which holds a bag in place of a scoop at the end of a pole. Though possibly a little less expensive to produce, it suffers from a) the increased cost of specialized disposable bags, and b) a need to immediately recycle the material into a waste container (potentially with the bag itself). The result is that usage and ownership is more expensive than expected with this invention.

U.S. Pat. No. 6,237,972 (Harrison, 11/2002) holds a bag at the end of a short tube that has a slot allowing the tube to be pushed to surround the animal waste then trapping the waste in a bag that has been attached.

This new invention does not suffer from this previous shovel or scoop like approaches. The result is a clean-able, inexpensive way to have your pet and meet the obligations of cleanup with no mess, and at a much lower cost.

### BRIEF SUMMARY OF THE INVENTION

This device can be used interchangeably for either small animal or pet waste collection and disposal. Inasmuch the term pet and animal will be used interchangeably throughout this document.

This present invention is a device for collecting pet waste as it is created, or some time thereafter, and for doing so in a clean, safe, discrete, efficient and yet elegant manner. The present invention provides for compact storage and enables a user to readily collect and transport the waste without personal contact. By providing a convenient waste collection device that is convenient to carry and use, there will be an increase in the number of pet owners that will be responsible for their pets and associated waste.

This tool is designed to be manufactured of plastic or a similar material; in a single or multi-part mold process. It incorporates a handle and a place that a plastic bag can be attached. The interior of the tubular body and scoop is smooth and with minimal cavities that would otherwise trap or interfere with the collection of pet and animal debris. This characteristic is an integral part of the design.

Because it is constructed through the molding process, it is far less expensive to manufacture, has no moving parts, can be easily cleaned, is very light weight, is easy to operate and maintain, and can be stored with contents still bagged. It is believed by the inventor that this invention makes pet waste and the required cleanup less of a burden both in initial purchase of the product and in the associated operating expenses.

Further objects and advantages of this invention will be inherent from the drawings and descriptions.

### BRIEF DESCRIPTION OF THE SEVERAL VIEWS OF THE DRAWINGS

The object and improvement of this invention is best understood from the wording of the detailed description when taken in context with the drawings supplied here within. These drawings are detailed to be informative and may not reflect the actual item, scale, or proportions. They are not intended to be the complete representation of the invention, and should not be interpreted in a way that limits the scope of the invention otherwise detailed in other parts of this document.

FIG. 1 is a perspective view of minimized version of the tool.

FIG. 2 is a side view of the minimized version of that tool.

FIG. 3 is a perspective view of the elongated version of the tool.

FIG. 4 is a side view of the elongated version of the tool.

FIG. 5 shows the shovel-like edge accumulating the pat waste

FIG. 6 shows the accumulation the pet waste through the pivoting of the shovel-like scoop.

FIG. 7 is a user holding the device in the normal standing upright position.

FIG. 8 shows the flick of the wrist action rotating the tubular body to an angle around 90 degrees from ground reference.

### DETAILED DESCRIPTION OF THE INVENTION

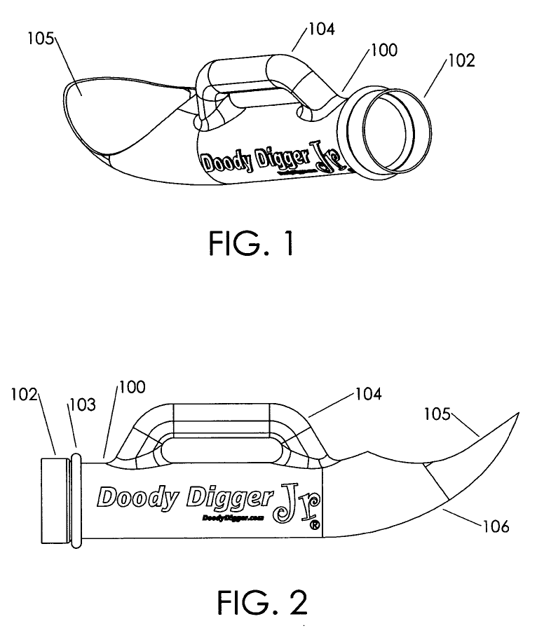

The device as seen in FIG. 1, 2, 3, and 4 is a device made in either a one or two piece mold, that allows the device to be easy to clean without cracks and crevasses in the path of the waste material. By using a non-porous plastic (such as HDPE, high density polyethylene) which is most suitable for plastic molding processes (such as a Blow Mold) a tube is created that is extremely easy to clean, light weight, wear-resistant and best of all inexpensive to manufacture and ship. When made in this manner, the device is free from embedded and hard to remove material left from the device's use. Waste material is likely to build up over time, but because the device is made of an extremely non-porous material, it will easily clean-up with a garden hose.

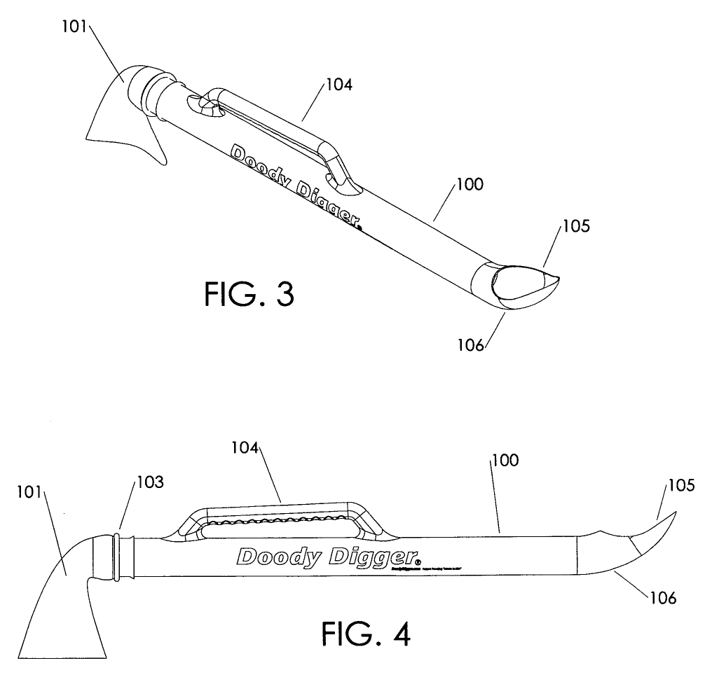

The device in its various forms as shown in FIG. 1, 2, 3, and 4 includes a bag retainer 102 that allows a plastic bag 101 (as shown in FIGS. 3 and 4) to be temporarily attached to the tube 100 using an rubber retaining band 103 (rubber band, O-Ring, or similar rubber product) to trap the plastic bag between the retaining band and the tube itself. Such a bag retainer 102 prevents the retaining band 103 from rolling off the end of the tube and aids in the control of the retained plastic bag 101.

The device includes an embedded handle 104 that is incorporated into the mold so that is can be made for a substantially reduced cost. Further, because the handle 104 is so incorporated areas and edges are unlikely to allow debris to form and accumulate. Such is a value added feature with no added cost to the manufacturer. The device includes an integrated scoop 105 and angular adapter 106 fixed to an angle that places the scoop in a usable position to effect the best user ergonomics.

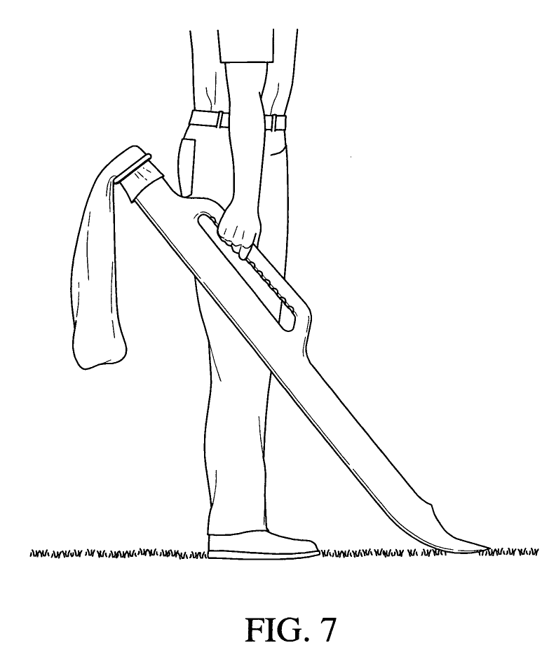

When used as intended and as shown in FIG. 7 the user can collect and dispose of pet or animal waste from a standing position (when using the elongated tool shown in FIGS. 3 and 4), or from a crouched position (when using the minimized tool as shown in FIGS. 1 and 2). This invention allows the user to collect the pet or animal waste using one hand with slight wrist moments, and while controlling the faithful pet with the other hand.

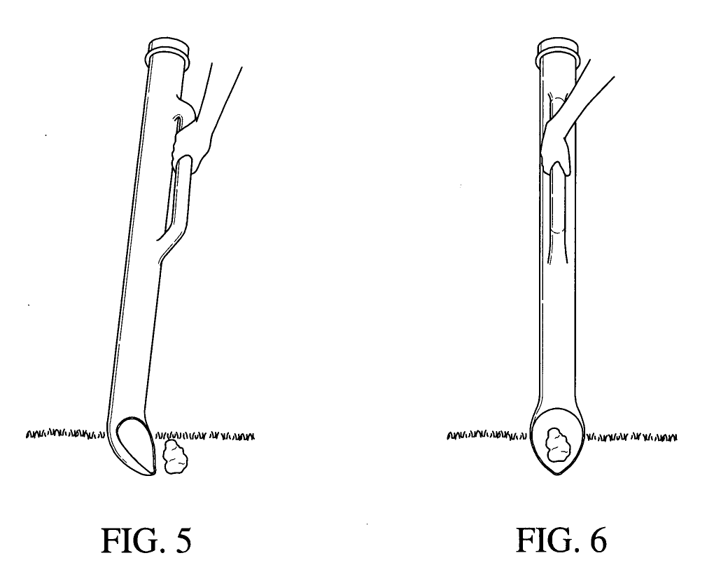

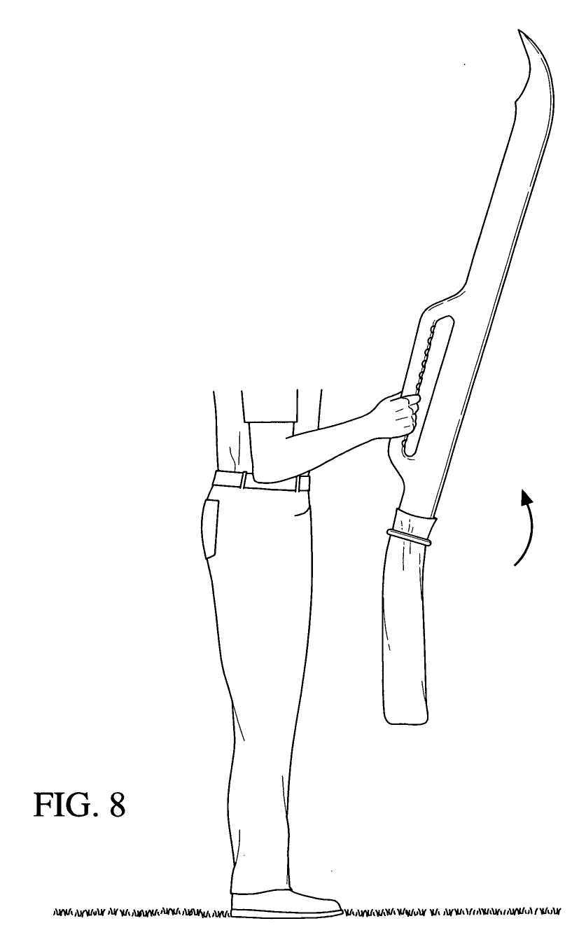

The device is operated (as shown in FIGS. 5 and 6) by setting the edge of the shovel-like scoop at the pet waste (as shown in FIG. 5) and by rotating this shovel-like scoop about the shovel point the waste can be scooped (as shown in FIG. 6) with no more than a twist of the wrist. Then by rotating the device (as shown in FIG. 8) to an angle of roughly 90 degrees (from ground reference) the waste can be slid from the scoop to the disposal bag. Afterwards, the bag can be left attached and the entire tool bag and all can be stored outdoors or in the user's garage without fear for weathering the device.

I claim:

1) An animal waste collection and disposal device comprising:
a) a scoop, slide or similar device that accumulates the animal debris;
b) a tubular body with said scoop, slide or similar device at one end, and an opening for the user to attach a disposable bag or similar device at the other end; with said tubular body long enough to accommodate said animal waste collection and disposal device's usage while held at an angle of approximately 20 and 50 degrees from ground reference during debris accumulation when the user is standing full upright or in a crouched position; and
c) a handle that is attached to said tubular body at both ends of said handle;
whereby the user can pivot or flick his or her wrist, thereby moving said animal waste collection and disposal device in a teeter-tooter-like motion, to an angle approximately 90 degrees from ground reference, to thereby dispose of the debris.

2) The animal waste collection and disposal device of claim #1 wherein said scoop is a rounded shovel-like scoop that accumulates the animal debris by rotating said rounded shovel-like scoop about its point;
whereby the user can collect the debris by twisting his or her wrist.

3) The animal waste collection and disposal device of claim #1 wherein said handle is long enough for a human hand to grip and is roughly parallel to the tubular body with sufficient distance between said handle and said tubular body for a human hand to fit comfortably between.

4) The animal waste collection and disposal device of claim #1 wherein said disposable bag or similar device is attached to said tubular body by an o-ring or similar device.

5) The animal waste collection and disposal device of claim #1 wherein said tubular body has a retaining device incorporated near said opening, whereby said disposal bag may be attached to said animal waste collection and disposal device by an o-ring or similar device.
